(19) United States
(12) Patent Application Publication
(10) Pub. No.: US 2005/0234847 A1
(43) Pub. Date: Oct. 20, 2005

(54) Information storage apparatus, information storage method and information storage processing program

(76) Inventors: Le Moal Damien, Sagamihara (JP); Yoshiaki Morimoto, Kawasaki (JP); Mika Mizutani, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/873,189

(22) Filed: Jun. 23, 2004

(30) Foreign Application Priority Data
Apr. 15, 2004 (JP) P2004-120518

(51) Int. Cl. G06F 7/00

(52) U.S. Cl. 707/1

(57) ABSTRACT

To allow a magnetic disk apparatus, such as an HDD, to perform real-time writing and reading of stream data or the like, the whole area of the disk is divided into a high reliability area and a low reliability area. The high reliability area is contiguous blocks to store reliability-critical data, whereas the low reliability area is contiguous blocks to store data which do not require high reliability. The high reliability area is divided into various management information storage areas, a metadata area and a high reliability data area to store reliability-critical data, such as encryption keys and programs. In the low reliability area, such data as image information having a real-time nature is stored.

### BACKGROUND OF THE INVENTION

The present invention relates to an information storage apparatus, information storage methods and information storage processing programs. In particular, the invention relates to an information storage apparatus, information storage methods and information storage processing programs of the type which are used to record and reproduce AV data and other stream type data.

In recent years, it has become common to enjoy music, image data and other multimedia information by using a home-use apparatus. Accordingly, there has been an increased demand for inexpensive products which can highly reliably record/reproduce multimedia information (also called stream data), such as music and image data, in real time. To meet this demand, various techniques have been proposed and are known. For example, Japanese Patent Laid-Open No. 2001-134495 describes a technique which optimizes data access by taking into consideration the type and content of the data to be accessed and its relations with other data during access. In addition, Japanese Patent Laid-Open No. 2000-148604 describes a technique which optimizes data access retry processing according to differences among data in terms of reliability, speed and other access requirements. Further, a technique disclosed in Japanese Patent Laid-Open No. 2004-5243 allows large-sized real-time file data to be stored efficiently, while reducing the degree of fragmentation which would otherwise be generated as a consequence of storing and deleting small-sized file data repeatedly.

These methods can be applied advantageously to HDD and other recording/reproducing magnetic disk apparatus, in a case where music, image data and other multimedia information having a real-time nature, intermingled with other data, are recorded and reproduced therewith.

In these methods, however, consideration has not been given to the cost of a home-use apparatus to implement them. In particular, recent storage devices for home-use apparatus may use low cost fabrication methods combined with disk certification (test) processes designed to reduce the amount of tests done on a disk for testing and remapping faulty sectors. Such disks may result in higher error rates on certain known areas, which is a characteristic not used by prior methods for optimizing performance. In addition, writing and reading multimedia information or stream data having a real-time nature imposes a large load on the controller and, therefore, may result in non real-time recording/reproducing.

### SUMMARY OF THE INVENTION

Taking the foregoing into consideration, it is an object of the present invention to provide a low-cost information storage apparatus, an information storage method and an information storage processing program which will allow HDD and other disk devices, including price-critical home-use apparatus, to perform real-time writing and reading of stream data or the like.

According to the present invention, the above-mentioned object is attained by an information storage apparatus having a file system stored in a storage unit, wherein the file system performs data writing to and data reading from the storage unit, comprising: a main memory into which the file system is loaded; and a processor which runs the file system; wherein the file system: divides the storage space of the storage unit into a high reliability area and a low reliability area and manages the high reliability area and the low reliability area separately; and stores data in the storage unit in such a manner that management data or encryption key data is stored in the high reliability area, whereas contents data is stored in the low reliability area.

In addition, the above-mentioned object is attained by an information storage method in an information storage apparatus having a file system stored in a storage unit wherein the file system performs data writing to and data reading from the storage unit, comprising the steps of: providing a processor which runs the file system loaded into a main memory; dividing the storage space of the storage unit into a high reliability area and a low reliability area to separately manage the high reliability area and the low reliability area; and storing each data in the storage unit in such a manner that management data or encryption key data is stored in the high reliability area, whereas contents data is stored in the low reliability area.

According to the present invention, it is possible to provide a low-cost home-use storage apparatus that is capable of performing high reliability recording and reproducing of stream data in real time.

### BRIEF DESCRIPTION OF THE DRAWINGS

FIG. 1 is a block diagram showing the hardware configuration of a file system according to an embodiment of the present invention;

FIG. 2 is a diagram illustrating a software configuration according to an embodiment of the present invention, downloaded into a RAM from an HDD shown in FIG. 1;

FIGS. 3(a) and 3(b) are diagram showing file fragmentation and I/O fragmentation in conjunction with file fragmentation;

FIG. 4 is a diagram which shows I/O fragmentation in conjunction with memory buffer fragmentation;

FIG. 5 is a diagram showing how data is allocated to the area on the disk according to the embodiment of the present invention;

FIG. 6 is a table which shows the configuration of file system management information stored in the storage area therefor;

FIG. 7 is a diagram which shows the configuration of metadata stored as file management information in the metadata area;

FIGS. 8(a) and 8(b) are tables which show the format of metadata expanded in the memory by the file system to handle the file;

FIG. 9 is a flowchart showing the initializing procedure performed by the file system;

FIG. 10 is a flowchart showing the procedure used to initialize the file system;

FIGS. 11(a) and 11(b) are tables illustrating a method of determining whether a file is to be stored in the high reliability area or in the low reliability area;

FIG. 12 is a flowchart showing a procedure to be followed when a file is opened;

FIG. 13 is a flowchart showing a procedure to be followed when a file is closed; and

FIG. 14 is a flowchart showing a procedure to be followed when a file is written to the disk.

### DESCRIPTION OF THE PREFERRED EMBODIMENTS

With reference to the drawings, a detailed description of a storage device control method and a file system which are implemented/embodied in accordance with the present invention will be described.

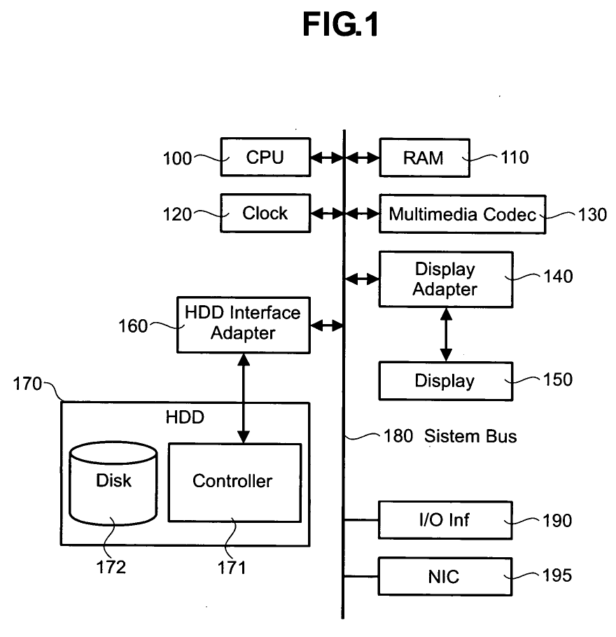

FIG. 1 is a block diagram showing the hardware configuration of a file system according to an embodiment of the present invention. In FIG. 1, the file system includes a CPU 100, a RAM 110, a clock source 120, a multimedia codec 130, a display adapter 140, is a display 150, an HDD interface adapter 160, an HDD 170 including, a disk controller 171 and, a disk 172, a system bus 180, an I/O interface 190 and is a network interface controller (NIC) 195.

The CPU 100 provides general control of the system. The RAM 110 serves as a main memory to store application programs and others software which is downloaded and used by the CPU 110 to perform control processing. The clock source 120 supplies a clock signal which is used throughout the system. The multimedia codec 130 performs encoding and decoding of multimedia information. The display 150 displays images, etc. The display adapter 140 performs display control for the display 150. The HDD 170 stores various data and multimedia information as well as application programs which are used by the CPU 100. The HDD interface adapter 160 controls data writing/reading to/from the HDD 170. The network interface controller 195 transmits and receives multimedia information via a communication line. The I/O interface 190 is connected with devices, such as an input unit, to receive operation commands. The file system is constituted by these components which are interconnected via the system bus 180. The HDD 170 comprises a magnetic disk 172, which is a medium on which to record data, and a disk controller 171 which controls writing/reading to/from the magnetic disk 172.

The above-mentioned file system can be configured not only as a server to provide multimedia information, but also as a home use apparatus, such as an HDD-incorporated video recorder. If the file system is configured as a video recorder, a TV tuner and an audio amplifier for speakers are connected to the system bus 180 via an interface circuit.

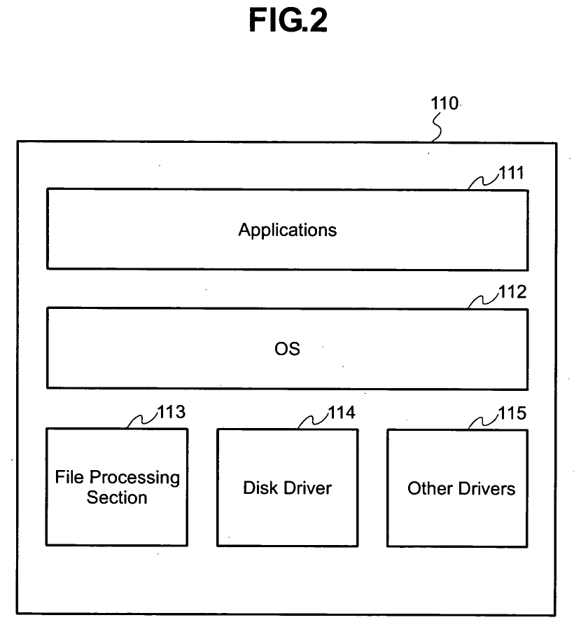

FIG. 2 shows a software configuration according to an embodiment of the present invention. The software, downloaded from the HDD 170, is configured, as shown, in the RAM 110 of FIG. 1. In FIG. 2, reference numeral 111 denotes applications, reference numeral 112 denotes an OS, reference numerals 113 denotes a file processing section, reference numeral 114 denotes a disk driver and reference numeral 115 denotes other drives.

The file processing section 113 in FIG. 2 performs processing to operate the file system in cooperation with the applications 111 according to the present invention. Although the applications 111 may be of any types, that application used for processing of the file system according to the present invention includes processing to label each file as either a file consisting of reliability-critical data or a file consisting of image information and other data having a real-time nature, but not requiring high reliability when the file is opened for writing to the HDD 170. The disk driver 114 supplies the interface adapter 160 of the HDD 170 with various types of control information, data and the like required to access the HDD 170. The other drivers 115 supply an FD, CD, input device, display 150 and other various devices with various control information, data and the like required to control them. The OS 112 controls all of these software functions, as described above, in an integrated manner. There are various types of OSs known and used in various types of apparatus. In the embodiment of the present invention, the OS 112 may be of any type.

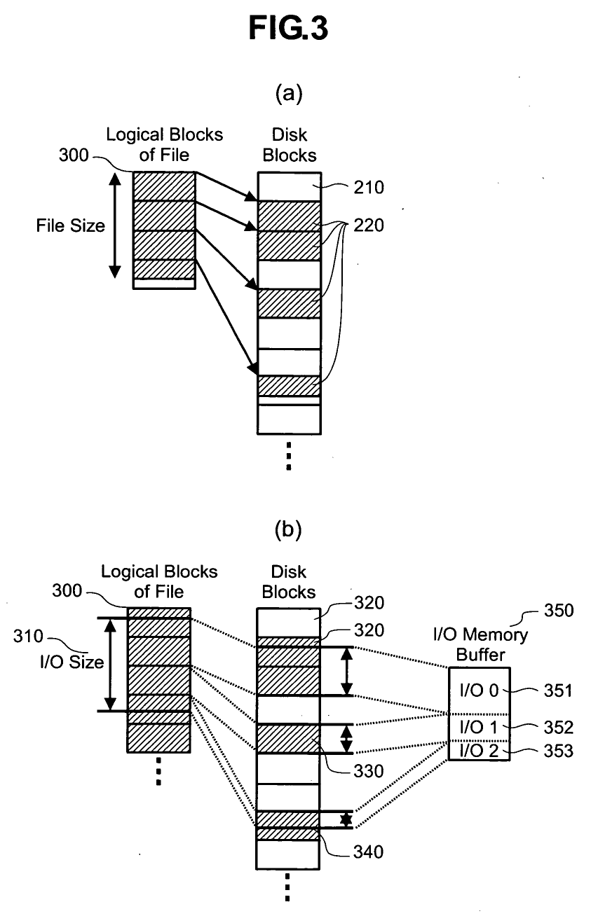

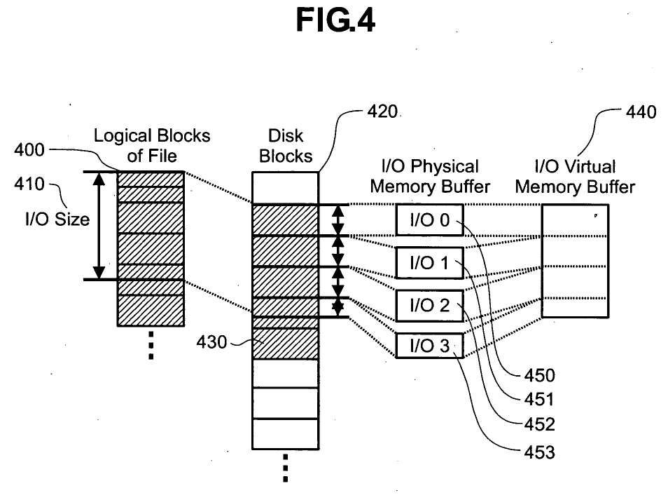

FIGS. 3(a) and 3(b) are provided to explain file fragmentation and I/O fragmentation in conjunction with file fragmentation. FIG. 4 is provided to explain I/O fragmentation in conjunction with memory buffer fragmentation.

As shown in FIG. 3(a), storing a file 200 of the file system generally results in a fragmented file stored in plural blocks 220 of the disk. Fragmentation of the file 200 and its allocation to the plural blocks 220 is under management of the file system. Since accessing the disk is done in blocks, accessing a single file requires a number of accesses depending on the block size. Each time a seek operation is made to locate the head on a block, data transmission is carried out. That is, dividing a file into many pieces of blocks lowers the processing speed and increases the system overhead since a seek operation must be performed to access each of the many blocks.

In addition, as shown in FIG. 3(b), access to the disk is usually done via an I/O memory buffer 350. In this figure, portions 351, 352 and 353 of the I/O memory buffer 350 are respectively used to access a stored file 310 that is scattered among plural blocks 320, 330 and 340. Accordingly, not only allocation of the file to non-contiguous blocks, but also use of the I/O memory buffer 350, must be under management of the file system. This also increases the system overhead.

This problem in conjunction with file fragmentation is eliminated if each file of the file system can be stored in contiguous blocks of the disk via an I/O memory buffer that is capable of treating the whole of each file. Even in this case, however, I/O fragmentation may occur, as illustrated in FIG. 4.

This example in FIG. 4 indicates that, even if a file 400 of the file system is allocated to contiguous blocks 430, the physical I/O buffer may be divided into plural memory areas 450 through 453. For example, although it is possible to configure a file system on a virtual computer system so that a virtual I/O memory buffer 440 can treat the whole of the file 410 of the I/O size as a continuous one, the file is divided into plural pieces when it is allocated to the physical I/O buffer. Also, in this case, allocation to the physical I/O memory buffer must be performed under management of the file system, which increases the system overhead.

The present invention is intended to decrease such file fragmentation in order to allow efficient disk accesses. According to the present invention, the whole area of a disk device is divided into an area to store data requiring high reliability and an area to store data not requiring high reliability. Data accesses to these different areas can be optimized differently in a retry operation, etc.

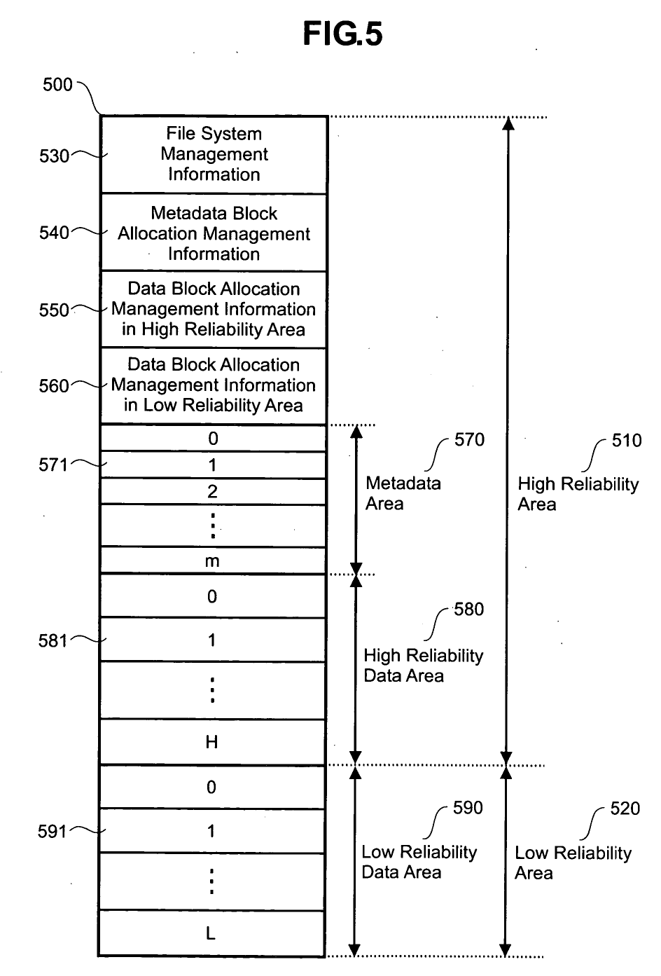

FIG. 5 is a diagram illustrating how data is allocated to the disk in the embodiment of the present invention. The following describes the layout.

The whole area 500 of the disk is divided into a high reliability area 510 and a low reliability area 520. The high reliability area 510 is made up of contiguous blocks to store reliability-critical data, whereas the low reliability area 520 is made up of contiguous blocks to store data which does not require high reliability. This division can be determined by the system designer when the system is designed. It may also be determined in such a manner that the disk is partially checked and the checked area is set as the high reliability area 510, whereas the unchecked area is set as the low reliability area 520. Generally, after an HDD is manufactured, the whole surface of each disk is checked. This whole surface check requires much time and, therefore, increases the cost of the HDD. Leaving an area as an unchecked low reliability area contributes to a lowering of the cost of manufacture of the HDD. The boundary between the high reliability area 510 and the low reliability area 520, that is, the respective sizes of the high reliability area 510 and low reliability area 520 can be changed as instructed by the file processing section 113, while the file system is running.

The high reliability area 510 is divided into a file system management information storage area 530, a metadata block allocation management information storage area 540, a high reliability data block allocation management information storage area 550, a low reliability data block allocation management information storage area 560, a metadata area 570 having contiguous blocks 571 and a high reliability data area 580 having contiguous blocks 581. Each area is organized as a continuous area. In the high reliability data area 580, reliability-critical data, such as encryption keys and programs, are stored. For this data, retry processing, sector remap processing and the like are performed to raise the reliability.

The low reliability area 520 is organized as a low reliability data area 590 having plural contiguous blocks 591. In this low reliability data area 590, data requiring real time processing, such as image information, sequential data, such as streaming contents, and other ordinary data, are stored. In this embodiment of the present invention, such reliability-raising operations as retry processing is not performed for the data which is stored in the low reliability data area 590. If performed, such operations are designed so as not to impair the real-time nature of the data, that is, not to cause remarkably delayed image/sound reproduction, sound-to-image asynchronism, etc. This makes it possible to quickly access data stored in the low reliability data area 590. Image information stored in the low reliability data area 590 can be encrypted so as to allow only specific users to enjoy it. Encryption keys for this purpose are stored in the high reliability data area 580.

In this embodiment of the present invention, as described above, the disk space is divided into a continuous high reliability area and a continuous low reliability area, and the high reliability area is further divided into continuous storage areas for metadata and other management data and another continuous storage area for encryption keys, programs and other data. Therefore, since management data is not intermingled with non-management data, non-management data stored in the high reliability and low reliability areas can be treated as large sets of contiguous data. Accesses to this data and the accompanying operations can therefore be performed at high speed.

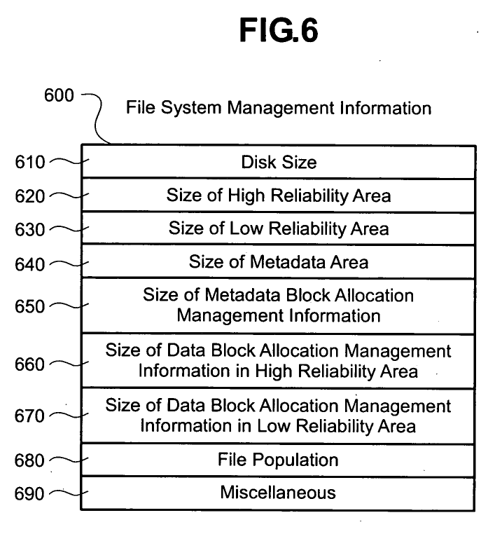

FIG. 6 shows an example of the configuration of the file system management information 600 that is stored in the storage area 530. As shown, the file system management information 600 comprises the disk size 610, the high reliability area size 620, the low reliability area size 630, the metadata area size 640, the metadata block allocation management information size 650, the high reliability data block allocation management information size 660, the low reliability data block allocation management information size 670, the file population 680 and miscellaneous data 690. The metadata block allocation management information size 650 is the size of the metadata block allocation management information indicating metadata-stored plural blocks 571 in the metadata area 570. The high reliability data block allocation management information size 660 is the size of the high reliability data block allocation management information indicating high reliability data-stored plural blocks 581 in the high reliability data area 580. The low reliability data block allocation management information size 670 is the size of the low reliability data block allocation management information indicating low reliability data-stored plural blocks 591 in the low reliability data area 590.

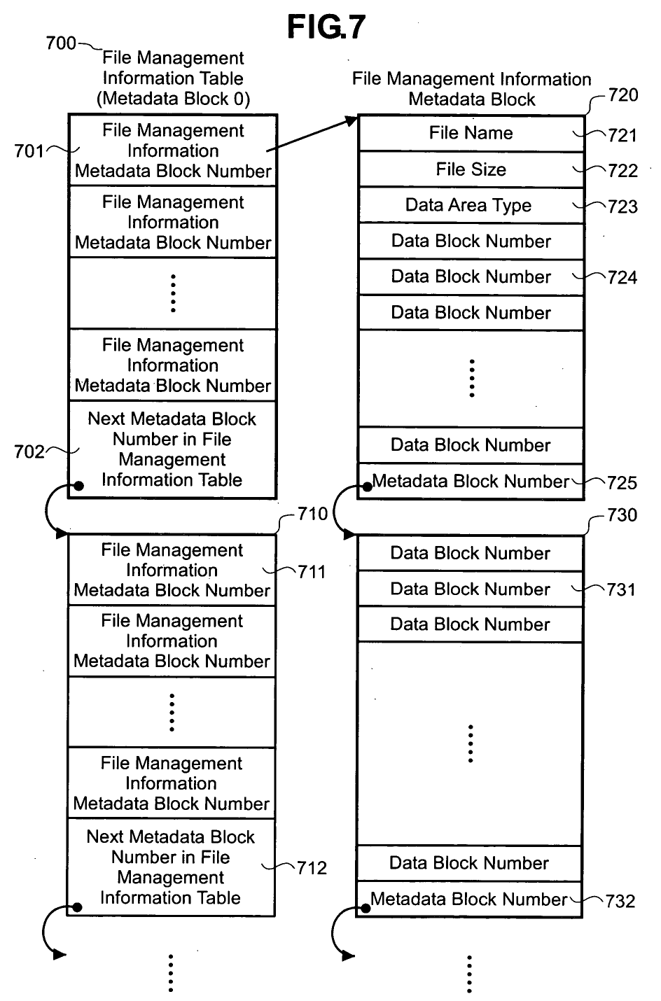

FIG. 7 shows an example of the configuration of metadata stored as file management information in the metadata area 570. Metadata 700 is data layout information indicating where data is recorded on the disk. Two metadata block numbers 701 and 702 constitutes one entry. The metadata block number 702 designates the subsequent metadata block which is linked to constitute one metadata. The metadata block number 701 designates one file management information metadata block 720, which specifies the name 721 of the file, the size 722 of the file, the type 723 (high or low reliability) of the data area, the data block numbers 724 of data blocks where the file is stored and the metadata block number 725 of the subsequent metadata block. By the subsequent metadata block number 725, the file management metadata block is linked to the subsequent metadata block.

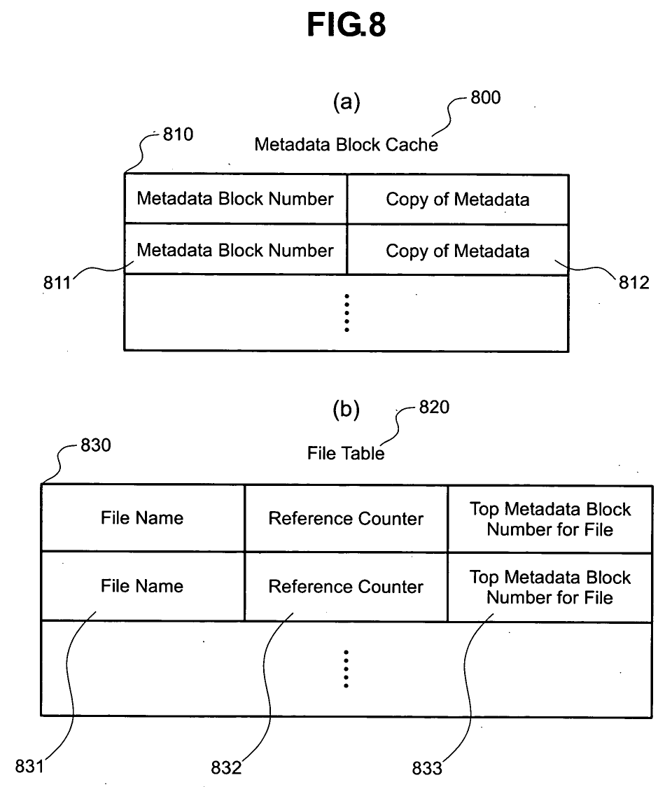

FIGS. 8(a) and 8(b) show an example of the format of metadata expanded in the memory by the file system used to handle the file. As shown in FIG. 8(a), plural records 810 are stored as management information in a metadata block cache 800. Each record comprises the metadata block number 811 and copy 812 of a metadata block read from the metadata area 570 on the disk, as described with reference to FIG. 7. In addition, a file table 820 is configured in the memory as shown in FIG. 8(b). In the file table 820, plural records are stored, each of which contains a file name 831, reference counter information 832 and the metadata block number 833 of the top metadata block for the file.

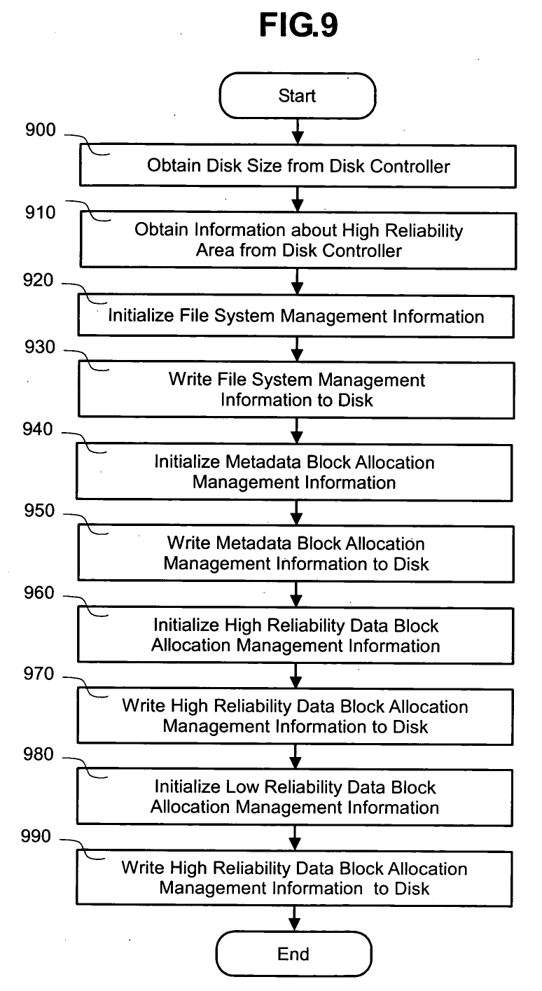

FIG. 9 is a flowchart illustrating the initializing procedure performed by the file system. As performed by the file processing section 113 shown in FIG. 2, this procedure determines the data layout of the disk, as described with reference to FIG. 5.
(1) Firstly, the disk size and information concerning the high reliability area 510 are obtained, including the management information areas 530 through 560, the metadata area 570 and the high reliability data area 580, as described with reference to FIG. 5, from the disk controller 171 (Steps 900 and 910).
(2) Then, the file system management information area 530 is initialized and file system management information is written into this area 530 (Steps 920 and 930).
(3) The metadata block allocation management information area 540 is initialized and metadata block allocation management information is written in this area 540 (Steps 940 and 950).
(4) The high reliability data block allocation management information area 550 is initialized and high reliability data block allocation management information is written in this area 550 (Steps 960 and 970).
(5) The low reliability data block allocation management information area 560 is initialized and low reliability data block allocation management information is written in this area 560 (Steps 980 and 990).

By performing this procedure, it is possible to lay out the disk, as described with reference to FIG. 5.

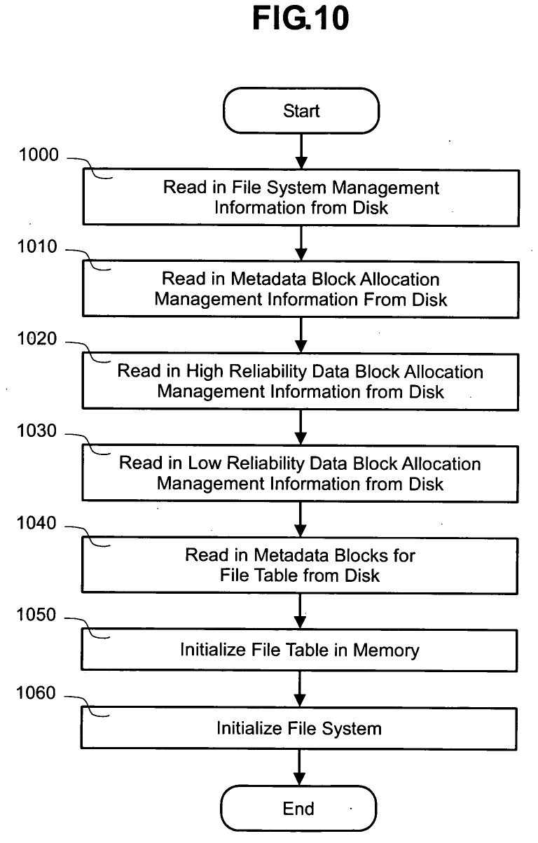

FIG. 10 is a flowchart illustrating the procedure to initialize the file system. This procedure is performed by the file processing section 113 shown in FIG. 2.
(1) File system management information and metadata block allocation management information are respectively read in from the file system management information area 530 and metadata block allocation management information area 540 on the disk (Steps 1000 and 1010).
(2) High reliability data block allocation management information and low reliability data block allocation management information are respectively read in from the high reliability data block allocation management information area 550 and low reliability data block allocation management information area 560 (Steps 1020 and 1030).
(3) Metadata blocks for the file table are read in from the metadata area 570 on the disk (Step 1040).
(4) The file table in the memory is initialized based on the information read out from the disk through the above steps, and, finally, the file system is initialized to complete this processing (Steps 1050 and 1060).

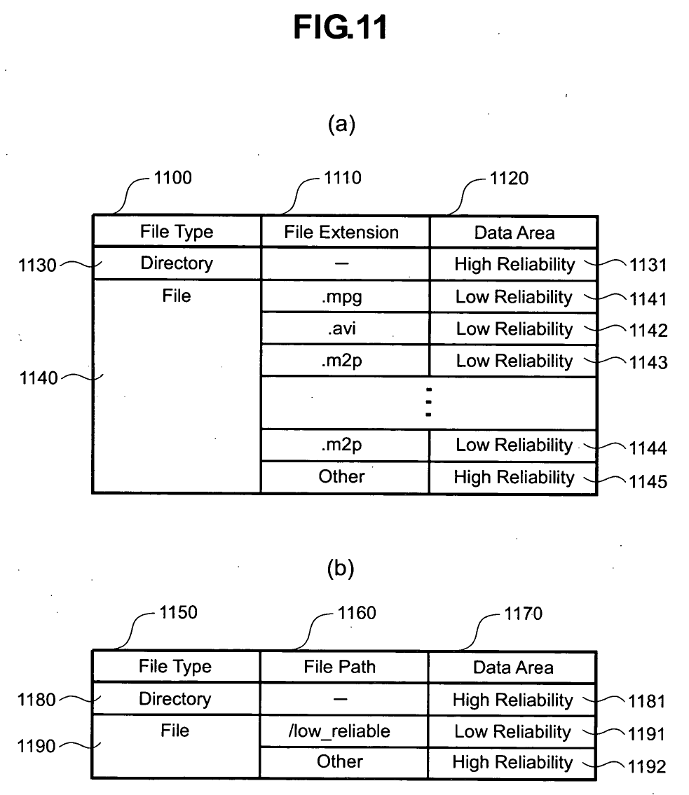

FIGS. 11(a) and 11(b) are provided to explain a method of determining whether a file is to be stored in the high reliability area 510 or in the low reliability area 520.

Generally, each file is given a file extension to indicate the type of file. Accordingly, a method which utilizes the file extension is available in this embodiment of the present invention as one method for determining whether a file is to be stored in the high reliability area or in the low reliability area. Specifically, in this embodiment of the present invention, data area information 1120 is set in advance into a table or the like prepared in one or plural blocks 581 of the high reliability data area 580. As shown in FIG. 11(a), data area information 1120 specifies whether a directory/file 1130/1140 is to be stored in the high reliability area or the low reliability area on the disk according to the file type 1100 indicating its type (file or directory) and the file extension 1110 expected to be given to it. When a file is stored on the disk, the area to store the file is determined according to this preset information.

In the example shown in FIG. 11(a), entry 1131 specifies that directories 1130 are to be stored in the high reliability area of the disk. Files with file extensions .mpg, .avi, .m2p, etc. are image data and other stream data files and, therefore, must be processed in real time. Accordingly, entries 1141 through 1144 specify that these files are to be stored in the low reliability area of the disk. As for files with other file extensions, such as .txt, entry 1145 specifies that these files are to be stored in the high reliability area of the disk.

While the file storage area determining method in the above-mentioned example uses file identifiers, some types of OSs treat files without giving them file identifiers. Accordingly, the present invention can also be configured so as to determine the storage area of each file by using file path information. In this alternate method, as shown in FIG. 11(b), data area information 1170 specifies whether a directory/file 1180/1190 is to be stored in the high reliability area or the low reliability area on the disk according to the file type 1150 indicating its type (file or directory) and the file path 1160 to be given to it. This information is set in advance into a table or the like. When a file is stored on the disk, the area used to store the file is determined according to this preset information.

In the example shown in FIG. 11(b), entry 1181 specifies that directories 1180 are to be stored in the high reliability area of the disk. Files having “low_reliable” set thereto as file path information 1160 are assumed to be image data and other stream data files which require real-time processing. Accordingly, entry 1191 specifies that these files are to be stored in the low reliability area of the disk. As for files having other file path information, entry 1192 specifies that these files are to be stored in the high reliability area of the disk.

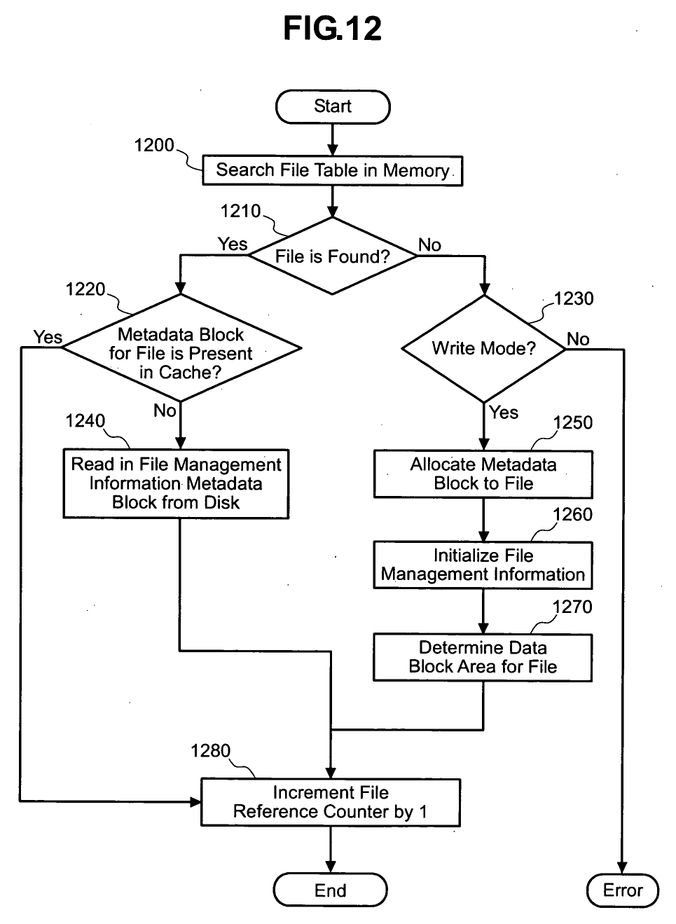

FIG. 12 is a flowchart illustrating a procedure to be followed when a file is opened. The following steps constitute this procedure.
(1) Firstly, the file table is searched in the memory and it is determined whether a file is found; and, if a file is found, it is determined whether a metadata block for the file is already present in the cache (Steps 1200, 1210 and 1220).
(2) If it is judged in step 1220 that a metadata block for the file is already present in the cache, the procedure is terminated after incrementing the file reference counter by “1” (Step 1280).
(3) If it is judged in step 1220 that no metadata block in the cache is for the file, all file management metadata blocks are read in from the disk and then the procedure is terminated after incrementing the file reference counter by “1” (Steps 1240 and 1280).
(4) If it is judged in step 1210 that no file is found, it is determined whether the file processing mode is a write mode, and, if it is not a write mode, the procedure is terminated as an error (Step 1230).
(5) If it is judged in step 1230 that the file processing mode is a write mode, a metadata block is assigned to the file and the file management information is initialized (Steps 1250 and 1260).
(6) A data block area is determined for the file and the procedure is terminated after incrementing the file reference counter by “1” (Steps 1270 and 1280). By using either method described in connection with FIGS. 11(a) and 11(b), it is determined whether the file is to be stored in the high reliability area or the low reliability area of the disk.

In step 1240, all file management metadata blocks are read from the disk. This makes it possible to treat a large file stored in a plurality of contiguous data blocks. In particular, stream data and other files having a real-time nature that are stored in the low reliability area can be processed in real time.

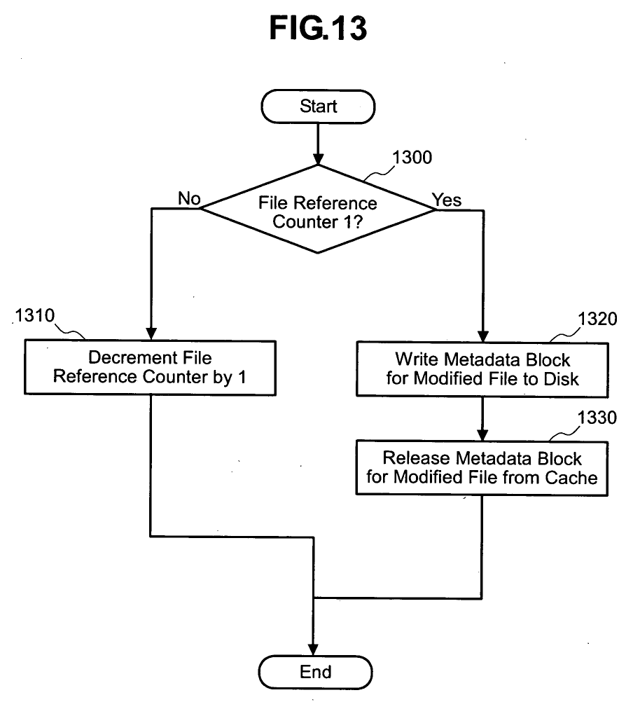

FIG. 13 is a flowchart illustrating a procedure to be followed when a file is closed. The following steps constitute this procedure.
(1) Firstly, it is determined whether the value of the file reference counter is “1” or higher, and if the value is higher than “1”, indicating that the file is opened also by another user, this procedure is terminated after decrementing the value of the file reference counter by 1 (Steps 1300 and 1310).
(2) If it is judged in step 1300 that the value of the file reference counter is “1”, indicating that the file is not being used by another user, the file's modified metadata block is written to the disk if modified (Step 1320).
(3) Then, this procedure is terminated after releasing the file's metadata block from the cache (Step 1330).

It is possible to allow the user to move the file from the high reliability area to the low reliability area or vice versa in the procedure mentioned above. This can be realized by adding the steps of creating a copy of the file and urging the user to choose a data block area in which the copy is to be stored.

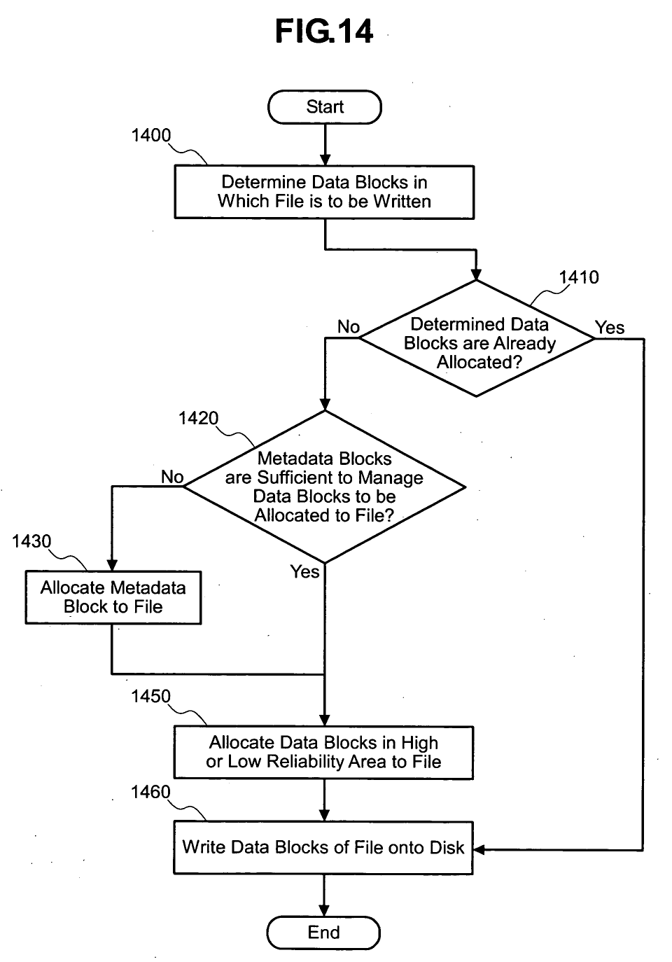

FIG. 14 is a flowchart illustrated a procedure to be followed when a file is written to the disk. The following steps constitute this procedure.
(1) Data block numbers are calculated. This calculation determines the number of required data blocks from the size of the file and then the data block numbers of contiguous data blocks in which the file is to be written is determined (Step 1400).
(2) It is determined whether the data blocks designated in step 1400 are all allocated to allow the file to be written therein, and, if allocated, the procedure is terminated after writing the file's data blocks in which to the disk (Steps 1410 and 1460).
(3) If it is judged in step 1410 that the data blocks in which to write the file are not all allocated, that is, that the file is enlarged to require more data blocks, it is determined whether the metadata blocks for the file are sufficient to manage the numbers of data blocks to be allocated for the file (Step 1420).
(4) If it is judged in step 1420 that the metadata blocks for the file are not sufficient, a metadata block is allocated to the file. If it is judged after this step or in step 1420 that the metadata blocks for the file are sufficient, the procedure is terminated after allocating data blocks to the file and writing the file's data blocks on the disk (Steps 1430, 1450 and 1460).

The aforementioned respective procedures in the embodiment of the present invention can be organized as a processing program. HD, DAT, FD, MO, DVD-ROM, CD-ROM and other recording media can be used to store and offer this processing program.

1. An information storage apparatus having a file system stored in a storage unit wherein the file system performs data writing to and data reading from the storage unit, comprising:
a main memory into which the file system is loaded; and
a processor which runs the file system;
wherein the file system:
divides the storage space of the storage unit into a high reliability area and a low reliability area and manages the high reliability area and the low reliability area separately; and
stores data in the storage unit in such a manner that management data or encryption key data are stored in the high reliability area whereas contents data are stored in the low reliability area.

2. An information storage apparatus according to claim 1 wherein when data stored in the high reliability area is accessed, at least either retry processing or sector remapping processing is performed.

3. An information storage apparatus according to claim 1 wherein when data stored in the low reliability area is accessed, neither retry processing nor sector remapping processing is performed.

4. An information storage apparatus according to claim 1 wherein when data stored in the low reliability area is accessed, such a level of retry processing or sector remapping processing is performed that the data access can be done in real time.

5. An information storage apparatus according to claim 1 wherein the high reliability area is composed of contiguous blocks and the low reliability area is also composed of contiguous blocks.

6. An information storage apparatus according to claim 1 wherein the high reliability area is an area on which a reliability check has been made in advance within the storage unit.

7. An information storage apparatus according to claim 1 wherein the boundary between the high reliability area and the low reliability area can be changed.

8. An information storage apparatus according to claim 1 wherein:
information is prepared which associates file identifiers respectively with storage areas; and
each data is stored in the high reliability area or the low reliability area which is associated with the data's file identifier by referring to said information.

9. An information storage apparatus according to claim 1 wherein said management data and said encryption key data are for data which are stored in the low reliability area.

10. An information storage method in an information storage apparatus having a file system stored in a storage unit wherein the file system performs data writing to and data reading from the storage unit, comprising the steps of:
providing a processor which runs the file system loaded into a main memory;
dividing the storage space of the storage unit into a high reliability area and a low reliability area to separately manage the high reliability area and the low reliability area; and
storing each data in the storage unit in such a manner that management data or encryption key data are stored in the high reliability area whereas contents data are stored in the low reliability area.

11. An information storage method according to claim 10 wherein when data stored in the high reliability area is accessed, at least either retry processing or sector remapping processing is performed.

12. An information storage method according to claim 10 wherein when data stored in the low reliability area is accessed, neither retry processing nor sector remapping processing is performed.

13. An information storage method according to claim 10 wherein when data stored in the low reliability area is accessed, such a level of retry processing or sector remapping processing is performed that the data access can be done in real time.

14. An information storage method according to claim 10 wherein the high reliability area is composed of contiguous blocks and the low reliability area is also composed of contiguous blocks.

15. An information storage method according to claim 10 wherein the high reliability area is an area on which a reliability check has been made in advance within the storage method.

16. An information storage method according to claim 10 wherein the boundary between the high reliability area and the low reliability area can be changed.

17. An information storage method according to claim 10 wherein:
information is prepared which associates file identifiers respectively with storage areas; and
each data is stored in the high reliability area or the low reliability area which is associated with the data's file identifier by referring to said information.

18. An information storage method according to claim 10 wherein said management data and said encryption key data are for data which are stored in the low reliability area.

19. A computer program product for an information storage apparatus having a file system stored in a storage unit, in which the file system performs data writing to and data reading from the storage unit, comprising the codes of:
loading the file system into a main memory;
dividing the storage space of the storage unit into a high reliability area and a low reliability area to separately manage the high reliability area and the low reliability area; and
storing each data in the storage unit in such a manner that management data or encryption key data are stored in the high reliability area whereas contents data are stored in the low reliability area.

20. A computer program product according to claim 19 wherein when data stored in the high reliability area is accessed, at least either retry processing or sector remapping processing is performed.

21. A computer program product according to claim 19 wherein when data stored in the low reliability area is accessed, neither retry processing nor sector remapping processing is performed.

22. A computer program product according to claim 19 wherein when data stored in the low reliability area is accessed, such a level of retry processing or sector remapping processing is performed that the data access can be done in real time.

23. A computer program product according to claim 19 wherein the boundary between the high reliability area and the low reliability area can be changed.

24. A computer program product according to claim 19 wherein:
information is prepared which associates file identifiers respectively with storage areas; and
each data is stored in the high reliability area or the low reliability area which is associated with the data's file identifier by referring to said information.
